(19) United States
(12) Patent Application Publication
(10) Pub. No.: US 2005/0246830 A1
(43) Pub. Date: Nov. 10, 2005

(54) Flow-through bathtub

(76) Inventors: Tinsley A. Galyean JR., Lewisburg, WV (US); Ewen Taylor Galyean, New Orleans, LA (US)

Correspondence Address: BROWN & MICHAELS, PC;400 M & T BANK BUILDING, 118 NORTH TIOGA ST, ITHACA, NY, 14850, US

(21) Appl. No.: 10/842,043

(22) Filed: May 7, 2004

(51) Int. Cl. A61H 33/02; A47K 3/02

(52) U.S. Cl. 4/584

(57) ABSTRACT

A continuous flow bathtub having at least two inlets on the head end of the tub, such that water enters the bathtub above a user's shoulders, flowing down over the bather's body and down to the water level in the bathtub, flowing out through an overflow trough at the foot end. This provides a luxurious experience of massage by clean, unused flowing water, without the need for expensive, complicated anti-siphon devices.

### BACKGROUND OF THE INVENTION

1. Field of the Invention

The invention pertains to the field of bathtubs. More particularly, the invention pertains to a bathtub designed to provide a continuous flow of fresh water around a bather.

2. Description of Related Art

Some early Roman baths, such as those at Bath, England, provided a “flow through” bathing system, in which water drawn from a natural hot spring was piped into a fountain on the north side of a hot pool called the “Great Bath”. A drain on the south side of the pool allowed the water to flow through a drainage system into the River Avon. Since those times, spas have grown up around natural hot springs around the world.

Conventional hydrotherapy tubs or spas typically are filled with water which is then moved around the bather by an impeller, or which is withdrawn from the tub, heated and recirculated through pumps and filters external to the tub and then injected back into the tub through jets. U.S. Pat. No. 3,374,492 is an example of such a therapeutic bathtub in which massage functions are provided by pumps which recirculate the water in the tub through jets in the sides of the tub. Similarly, U.S. Pat. No. 3,441,015 discloses a tub that has a recirculating system for the reused tub water, in which the recirculated water enters through underwater jets, and flows out through a drain at the surface of the water. In addition, an additional jet of recycled water is provided at surface level at one end, sweeping the surface clean of contaminants and debris.

Some bathers would like the therapeutic and massage effects of water flow in their tub, but would prefer to use unused, fresh water rather than recirculate the used water in the tub.

For practical reasons, all of the plumbing in a conventional bathtub is located at one end, nearly always the foot end, of the tub. Such tubs have a water inlet or faucet for filling the tub, and directly below the faucet on the bottom of the tub is a drain for emptying the water from the tub. Most tubs also have an overflow outlet located above the drain, often built into the drain activation lever assembly, so that water above a given level can drain rather than spill over. Rarely, the water inlet and drain are moved to the long side of the tub.

This arrangement, with water inflow and drain at the same end of the tub, means that if a bather wants to let in hot water while bathing, to approximate the therapeutic effects of a continuous-flow spa, the water immediately drains into the overflow under the faucet, with little effect on the temperature in the tub. Also, in a conventional tub the water is introduced at the foot end of the tub, or at the side, which does not provide the kind of body contact desired.

To counter this problem, a 1950 U.S. Pat. No. 2,529,568, discloses a bathtub in which there is an overflow spillway at the head end of the tub, from which the water is lead to the conventional foot-end overflow by troughs along the sides of the bathtub, similar to the overflow troughs in a swimming pool. Water enters the bathtub through a conventional faucet arrangement at the foot end of the tub, but the not water added during bathing must travel from the foot end to the head end to drain, so that added hot water is not immediately wasted down the drain.

A 1955 U.S. Pat. No. 2,705,329 shows a bathtub in which hot and cold water is introduced through two inlets in gutters located along the sides at the bottom of the tub. When the drain is open and water is continuously supplied to these inlets, the gutters in the tub direct the water along the sides of the tub, causing it to swirl around the bather to provide a constant, uniform temperature in the bathtub, before the water goes down the drain at the foot end of the tub. However, such an arrangement would be contrary to code in many parts of the country, since any water inlet below water level as is shown in this patent would require an anti-siphon device to prevent used bathwater from being introduced back into the municipal water system. Such devices are expensive, and require annual testing and certification.

U.S. Pat. No. 3,366,110 discloses a hydrotherapy tub for burn patients in which inlet water flows into a separate tank arrangement prior to flowing into a bathtub. Within the separate tank, an additional therapeutic solution of saline is added and mixed thoroughly with the incoming water, and the temperature of the diluted saline solution is maintained through a heater. The water containing the additional solution is then led through a hose to a conventional bathtub, where the hose can direct the saline wherever the solution is needed. In most cases, this would be against a patient's burns, underneath the current water level. Water drains out of the tub through a conventional overflow at the foot end.

In U.S. Pat. No. 3,374,492, mentioned previously, centrally located faucets on either side of the tub fill the tub with water. A central drain and overflow traps at the head and foot ends are also present. A user of the therapeutic bathtub may add hot water continuously from the faucets while bathing, allowing new water to flow in at the sides and out at the ends of the tub, but such water will not make direct contact with the bather. The water flow against the bather is provided by underwater jets of recirculated water powered by pumps.

U.S. Pat. No. 3,967,323 shows a bathtub that has a constant flow of water from inlets disposed around the bottom of the tub. The water level remains constant due to outlets on the side of the tub that act as overflow devices. Again, as in 2,705,329, expensive anti-siphon devices would be required to use this design in most parts of the country, to prevent siphoning of used bathwater into the water supply.

### SUMMARY OF THE INVENTION

The invention comprises a continuous flow bathtub having at least two inlets on the head end of the tub, such that water enters the bathtub above a user's shoulders, flowing down over the bather's body and down to the water level in the bathtub, flowing out through an overflow trough at the foot end. This provides a luxurious experience of massage by clean, unused flowing water, without the need for expensive, complicated anti-siphon devices.

### BRIEF DESCRIPTION OF THE DRAWING

FIG. 1 shows a top plan view of the present invention.

FIG. 2 shows a sectional view of the present invention along the lines 2-2 in FIG. 1.

FIG. 3 shows a perspective view of the present invention.

FIG. 4 shows a block diagram of the water flow in the present invention.

### DETAILED DESCRIPTION OF THE INVENTION

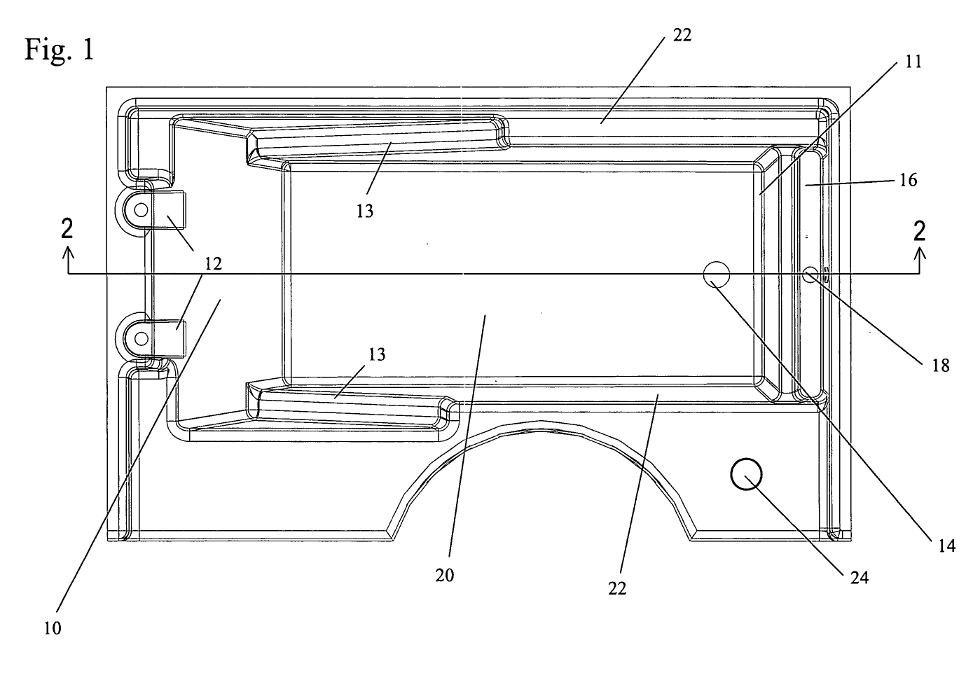

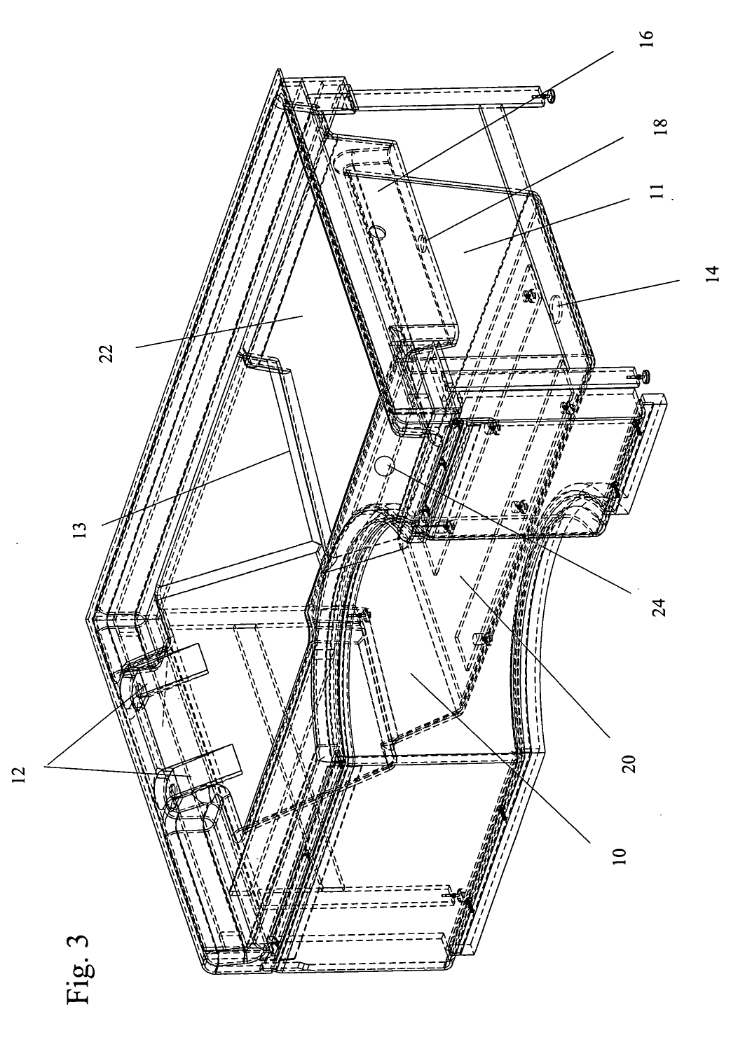

FIGS. 1-3 shows a therapeutic tub having a head end wall 10 joined to a foot end wall 11 by a bottom 20 and two side walls 22. An overflow trough 16 is present on the foot end wall 11, having a drain (or drains) 18. It is preferred to have two drains 18, but any number of drains sufficient to handle the flow of water could be chosen. Water from drain(s) 18 does not recirculate back into the tub, but is routed into the building drain system. Thus, when the tub is filled to the level of the trough 16, new water introduced at the head end 10 flows into the trough 16 and out the drain 18.

A faucet 24 for initially filling the tub is located near a side wall 22 of the tub. The faucet 24 may be in line with drain 14 on the bottom of the tub, if desired for aesthetic reasons, but this is not necessary. Bottom drain 14, which car, be closed with a conventional drain valve 46 or a simple stopper in the tub (not shown), allows the entire contents of the tub 10 to be emptied into the building drain piping 40. Again, for ease of plumbing, drain 14 may be in line with drain 18 of the overflow trough 16, but this is not necessary.

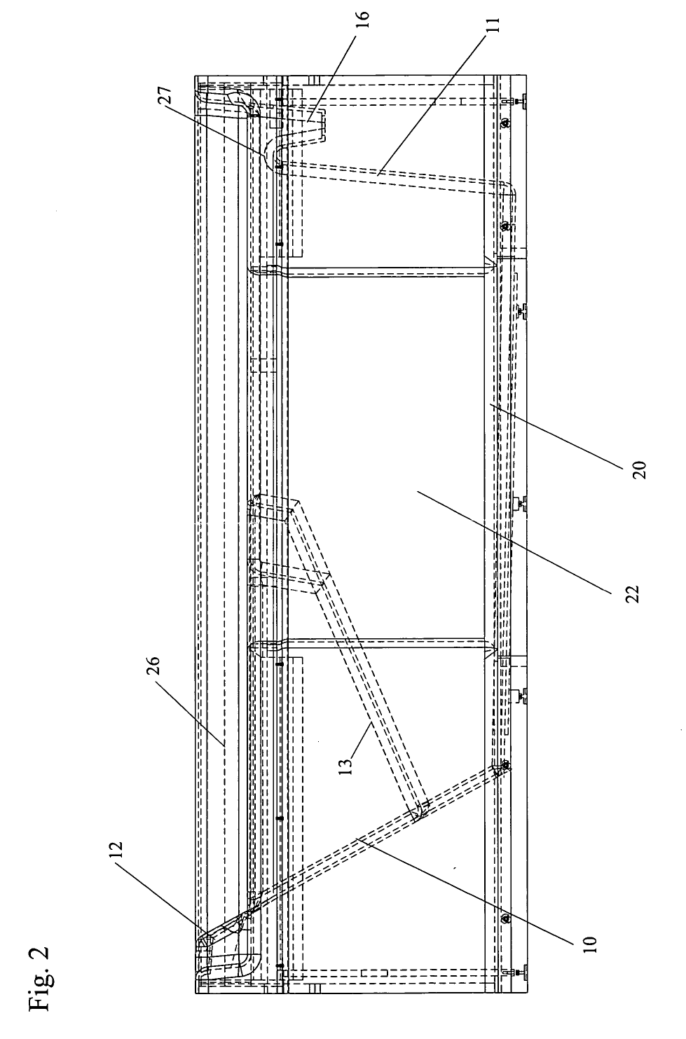

The side walls 22 of the tub 10 preferably contain ergonomically placed arm rests 13. The head end wall 10 of the tub is also preferably ergonomically slanted for a user's comfort, so that the user can recline against the head end wall, mostly submerged in the water. Water inlets 12 are located at the head end wall 10 such that water from the inlets 12 flows onto the nearly submerged user's shoulders as it enters the water level in the tub 27, as shown in FIG. 2. Also, the inlets 12 are located a sufficient distance above the deck or flood level 26 of the water in the tub, so as to avoid the requirement for an anti-siphon device. “Deck” is herein defined as the level of the tub that would be the highest point that the water would get to in the event that all the drains were blocked, above which the water would then spill over the deck onto the floor. If, as preferred, two inlets 12 are provided, the inlets 12 are spaced apart so that water from the two inlets flows over each of the user's shoulders.

The flow of water from the inlets is substantial enough to cause the water to flow from the head end 10 of the tub to the foot end 11 of tub, into the trough 16 and out through the overflow drain 18 into the plumbing drain system of the building 40.

Preferably, the water temperature is regulated by mixing the incoming hot 42 and cold 43 water streams. The temperature of the water and time of filling of the tub may be set by the user using an electronic control unit (ECU) 41 on the tub or located close to the tub, using a water temperature regulation unit such as the Hass Manufacturing Intellifaucet model K375, preferably customized with the controls remoted to a convenient location for the user. The water would preferably be at a selected temperature of approximately 100° F. for the initial filling of the tub, and the water incoming to the tub from the inlets 12 would preferably be regulated to a higher temperature of approximately 104° F.

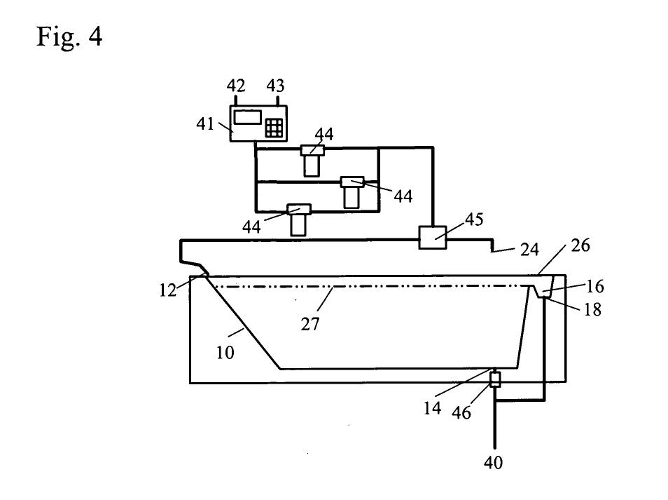

The water entering the tub 10 from either the faucet 24 or the two inlets 12 may be filtered or unfiltered water. Preferably, the water is filtered using a radial carbon filter 44 or other similar filter, which would be capable of operating for 115,000 gallons of water before needing replacement. Radial carbon filters model WRC25HD from American Plumber would be appropriate for this application. If sufficient flow cannot be maintained through a single filter unit, a number of filter units 44 may be arranged in parallel, as shown in FIG. 4.

A diverter valve 45 would also be present on the side wall 22 of the tub that allows the user to choose whether incoming water is diverted to the faucet 24 for filling of the tub or to the inlets 12 on the head end 10 of the tub. The divert valve 45 can be a mechanical valve, or could be electronically controlled, if desired.

While the above-described design is preferred, other additions and simplifications are possible within the teachings of the invention. If desired, the faucet 24 and diverter valve 45 could be omitted, and the tub filled through inlets 12. Also, the trough 16 could be omitted, and the overflow drain(s) 18 formed into the foot end 11 of the tub.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A bathtub comprising:
a head end, a foot end, a bottom and two side walls;
an overflow at the foot end, the trough being located such that water in the tub over a level is removed by the overflow;
at least two inlets for providing a flow of water into the bathtub, on the head end of the bathtub above water level and located such that water entering the bathtub through the inlets flows over a user reclining in the bathtub with the user's head at the head end of the bathtub.

2. The bathtub of claim 1, further comprising a drain on the bottom of the bathtub.

3. The bathtub of claim 1, wherein the two inlets are located such that water from the inlets hits a user's shoulders.

4. The bathtub of claim 1, further comprising at least one filter in series with the inlets such that water flow through the inlets is filtered.

5. The bathtub of claim 4, wherein the filter is a radial carbon filter.

6. The bathtub of claim 1, further comprising at least one faucet for filling the bathtub.

7. The bathtub of claim 1, further comprising a diverter valve for switching a source of water between the inlets and the faucet.

8. The bathtub of claim 1, further comprising a temperature regulator for controlling temperature of the water from a source of hot and cold water to the inlets.

9. The bathtub of claim 1, wherein the head end of the bathtub is slanted.

10. The bathtub of claim 1, in which the overflow comprises a trough and at least one drain, such that water over the level spills into the trough and flows out the at least one drain.

11. A method of providing a water bath using a bathtub comprising:
a head end, a foot end, a bottom and two side walls;
an overflow at the foot end, the overflow being located such that water in the tub over a level spills is removed by the overflow;
at least two inlets for providing a flow of water into the bathtub, on the head end of the bathtub above water level and located such that water entering the bathtub through the inlets flows over a user reclining in the bathtub with the user's head at the head end of the bathtub;
wherein the method comprises the steps of:
filling the tub with fill water at a selected temperature up to the overflow; and
introducing a flow of unrecirculated water at a regulated temperature through the at least two inlets such that the water flows onto the body of the user and is drained through the drain.

12. The method of claim 11, in which the selected temperature of the fill water is a lower temperature than the regulated temperature of the flow of unrecirculated water.

13. The method of claim 12, in which the selected temperature of the fill water is approximately 100° F.

14. The method of claim 12, in which the regulated temperature of the flow of unrecirculated water is approximately 104° F.

15. The method of claim 11, further comprising the step of filtering the flow of unrecirculated water.
